(19) United States
(12) Patent Application Publication
(10) Pub. No.: US 2022/0266244 A1
(43) Pub. Date: Aug. 25, 2022

(54) SWAB LYSIS TUBE

(71) Applicant: MBIO DIAGNOSTICS, INC., Boulder, CO (US)

(72) Inventors: Keagan Rowley, Boulder, CO (US); Brian Hicke, Boulder, CO (US)

(21) Appl. No.: 17/678,854

(22) Filed: Feb. 23, 2022

Related U.S. Application Data
(60) Provisional application No. 63/152,725, filed on Feb. 23, 2021.

(51) Int. Cl. B01L 3/00

(52) U.S. Cl. CPC B01L 3/5082; B01L 2200/16; B01L 2300/042; B01L 2300/0609; B01L 2300/123

(57) ABSTRACT

A swab lysis tube, comprising: a tubular body portion having an interior surface and an exterior surface, the interior surface further comprising an interior structure around the circumference of the tubular body portion at approximately the midpoint along the axis of the tubular body portion, and extending from the interior surface towards a center of the tubular body portion, said interior structures comprising a lower surface with a defined edge; a tapered tip at an end of the tubular body portion adjacent to the lower surface of the interior structure, said tapered tip having a cross-sectional area equal to the tubular body portion at one end, and a closed tip with a cross-sectional area smaller than that of the tubular body portion at the opposite end; and a cap retaining portion at a first end of the tubular body portion opposite the tapered tip.

### RELATED APPLICATIONS

This application claims priority to U.S. Patent Application Ser. No. 63/152,725, titled “SWAB LYSIS TUBE”, filed Feb. 23, 2021, which is incorporated herein by reference.

### FIELD

The present application relates to a tube for retaining samples collected using a swab.

### BACKGROUND

The health status of an individual may be determined by collecting a sample of body fluids or solids from an orifice such as a mouth or nose using a swab, or by using the swab to sample blood, feces, wounds, etc. The collected sample may include DNA, protein, mucus, blood, carbohydrates, lipids, intact or lysed cells, and viral particles that need to be placed in a solution for lysis or other analysis techniques. This solution is typically placed in a tube. The swab may be inserted into the tube so the collected fluids/solids come into contact with the solution in the tube to cause transfer of sampled material to the solution. The swab head is often rubbed against the side of the tube for sample extraction. Depending on the swab type, size, and tube flexibility, this method may not result in effective sample expression from the swab or may require a larger amount of solution in the tube.

### SUMMARY OF THE EMBODIMENTS

In a first aspect, a tube includes internal structures that provide a defined edge. After a collection swab has been inserted into the tube to leave sampled body fluids, it may be pressed against the sharp edge as it is withdrawn to express fluid retained within the swab back into the tube. The internal structure may have a variety of configurations so long as there is a defined edge facing the closed end of the tube.

### BRIEF DESCRIPTION OF THE FIGURES

FIG. 1 is a perspective view of a swab lysis tube, in embodiments.

FIG. 2 is a perspective view of the swab lysis tube of FIG. 1 showing internal structures, in embodiments.

FIG. 3 is a side view of the swab lysis tube of FIG. 1 showing internal structures, in embodiments.

FIG. 4 is a cross-section view of the swab lysis tube of FIG. 3, in embodiments.

FIGS. 5A and 5B are partial exploded views of the swab lysis tube of FIG. 2, with alternative embodiments of the internal structure of FIG. 2.

FIG. 6 is a perspective view of an alternate embodiment of the swab lysis tube of FIG. 1, in embodiments.

FIG. 7 is a cross-section view of the swab lysis tube of FIG. 6, in embodiments.

FIGS. 8A and 8B depict alternative embodiments of the internal structure as an annular ring, which include a series of ridges, in embodiments.

### DETAILED DESCRIPTION

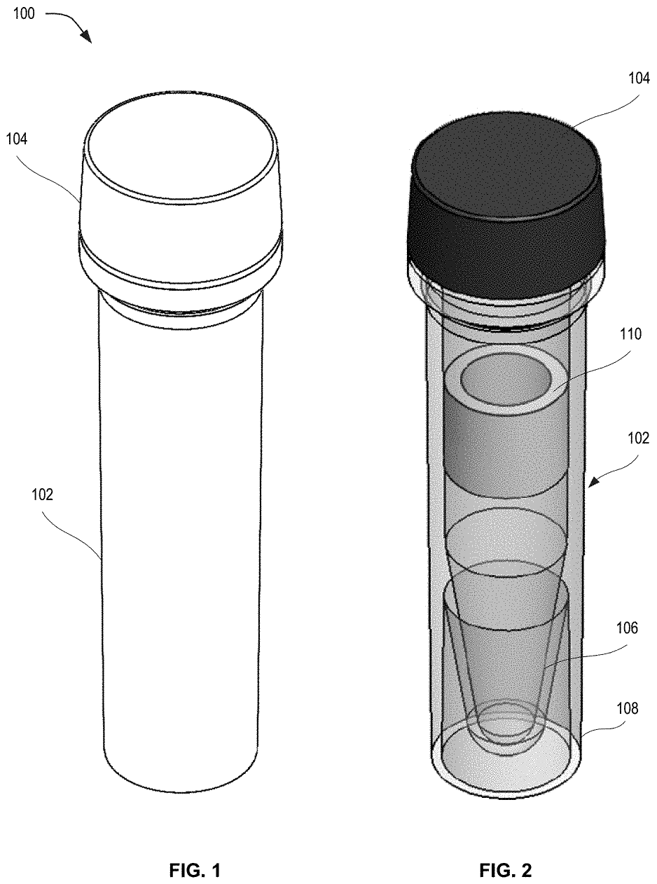

FIG. 1 is a perspective view of a swab lysis tube 100. FIG. 2 is a perspective view of the swab lysis tube of FIG. 1 showing internal structures, in embodiments. FIGS. 1 and 2 are best viewed together in the following description.

Tube 100 includes a tubular body portion 102 and a cap 104. Cap 104 may be attached to tubular body portion 102 using threads or a snap fit connection. Further, cap 104 may include two components: a first component that is attached for when inserting a swab into the tubular body portion to mix with a solution within the tube 100 and a second component that can detach from the first component or the cap 104 for when pouring the mix of fluid from the swab and the solution within the tube 102. When removing the second component from the cap 104, the detachment of the second component may result in an “easy-to-pour” configuration, such as within the first component.

Tubular body portion 102 has a tapered end 106 opposite cap 104. In embodiments, tapered end 106 may be any shape, such as a tapered, cylindrical, boxed, etc. In further embodiments, tapered end 106 is enclosed within a sleeve 108 but this is not essential. Sleeve 108 allows the tube 100 to be stood on end, with the tapered end 106 at the bottom of the tube 100 when standing on end. Tube 100 includes a tubular body portion 102 between cap 104 and tapered end 106 having interior and exterior surfaces. The tubular body portion 102 includes an internal structure 110 approximately midway between cap 104 and tapered end 106. Although shown as an annular ring, internal structure 110 may take a variety of forms as long as it includes a lower surface with a lower edge (such as a 90 degree edge, curved edge, and so on), as will be discussed in more detail below. The tubular body portion 102 may be composed on any material, such as a stiff plastic, polypropylene, and so on. In embodiments, the material composition is such that it cannot be deformed by squeezing or swab manipulation. In embodiments, tubular body portion may have a molded interior structure comprising of the defined edge are composed of flexible plastic, such as low-density polyethylene, such that it can be deformed by squeezing, bringing the tube 100 walls and internal edge into contact with the swab head for fluid/solid expression from the swab (not shown).

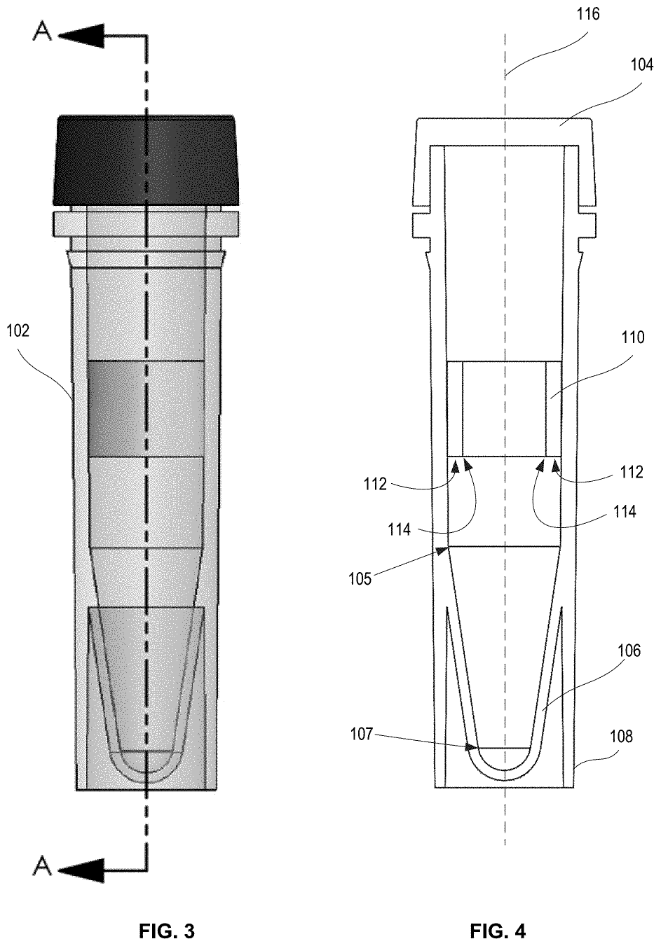

FIG. 3 is a side view of the swab lysis tube of FIG. 1 showing internal structures, in embodiments. FIG. 4 is a cross-section view of the swab lysis tube of FIG. 3 taken along line A-A of the tube corresponding to center axis 116. FIGS. 3 and 4 are best viewed together in the following description. Internal structure 110, shown as an annular ring, includes a lower surface 112 that is generally perpendicular to axis 116 of tube 100. Lower surface 112 includes a lower edge 114 at a side of the lower surface closer to center axis 116. Tapered end 106 may begin at a section 105 adjacent to the lower surface 112 of the interior structure 110, and have a cross-sectional area approximately equal to an outer area of the internal structure 110, and a closed tip 107 (e.g., rounded tip, and so on) with a cross-sectional area smaller than that of the first section at the opposite end, yet wide enough to match (e.g., within 1-2 mm) the diameter of a chosen swab head (not shown).

After a swab is used to collect a sample of body fluids from a person, the swab is inserted into tubular body portion 102 and placed in contact with a quantity of solution in tapered end 106. Because a swab is generally made of cotton or another absorbent material suited for collecting body fluids, it is also likely to absorb a significant proportion of the solution in tapered end 106. When withdrawing the swab, a user may press it against lower edge 114 to express some of the absorbed solution so it stays in tubular body portion 102. In embodiments, lower edge 114 may take any shape, such as a 90 degrees edge, a curved edge, and so on, to increase expression of the absorbed solution within the tubular body portion 102. In embodiments, lower surface 112 is positioned within tubular body portion 102 at a location approximately a few millimeters above the preferred height of a solution within tubular body portion 102. The height of internal structure 110 is flexible as long as it is above the preferred height of solution in tubular body portion 102 so any fluid absorbed by the swab can be expressed without rehydrating.

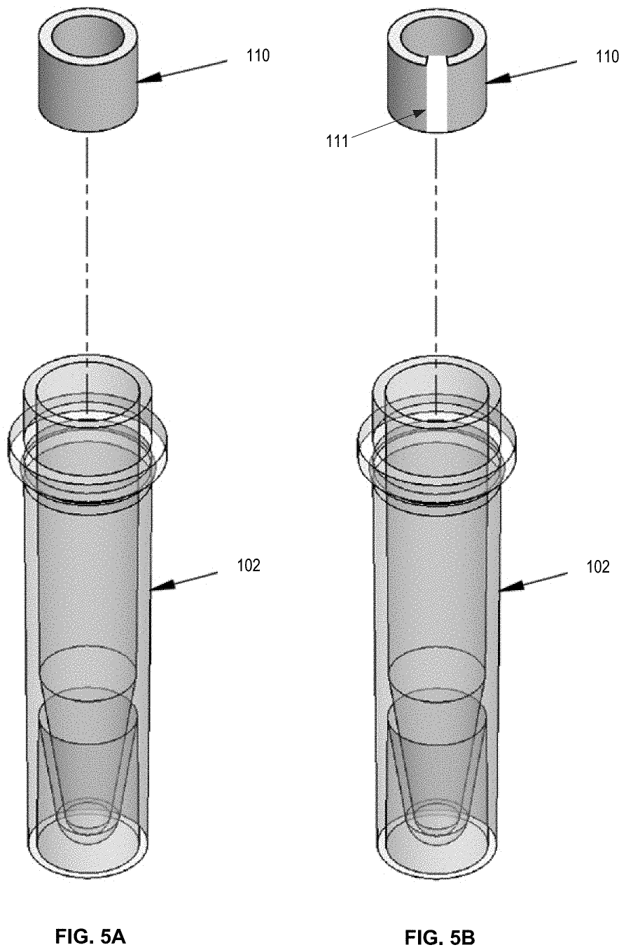

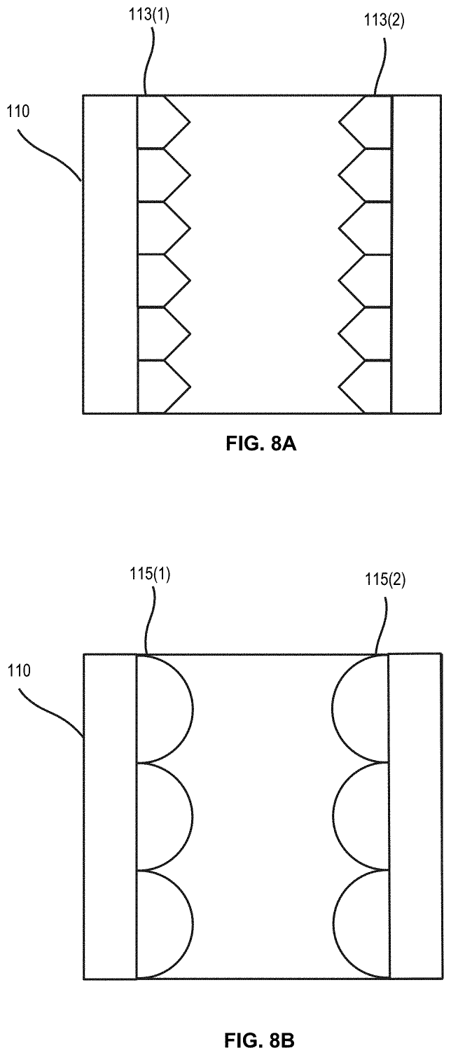

Although FIG. 4 depicts internal structure 110 as an annular ring with a length along axis 116, other embodiments are contemplated. For example, internal structure 110 may be a series of individual ridges (such as series of ridges 113(1), (2), with reference to FIGS. 8A, B) within approximately the same length as the ring depicted, or a longer length depending on the swab application. In addition, internal structure 110 may have a smaller internal circumference than depicted or may have a circumference that varies along its length. Additionally or alternatively, the internal structure 110 may define one or more grooves (such as groove 111) along the length of the internal structure 110 so as to allow the internal solution to drain past the internal structure 110 when tipped towards the end-cap end of the tube 102, as discussed with reference to FIG. 5B.

FIG. 5A is a partial exploded view of the swab lysis tube of FIG. 2, in embodiments. Internal structure 110 may be a separate device from tubular body portion 102 that is inserted with a friction fit into tubular body portion 102. Alternatively, internal structure 110 may be molded with tubular body portion 102 as a single apparatus. FIG. 5B is a partial exploded view of the swab lysis tube of FIG. 2, with a groove 111 in the internal structure 110. Groove 111 may allow for ease of dispelling fluid and/or solution from the tube 100, so that the fluid and/or solution has an egress from the tubular body portion 102 without blockage from the internal structure. In embodiments, internal structure 110 may have more than one groove 111 shaped in any configuration such that egress of fluid increases.

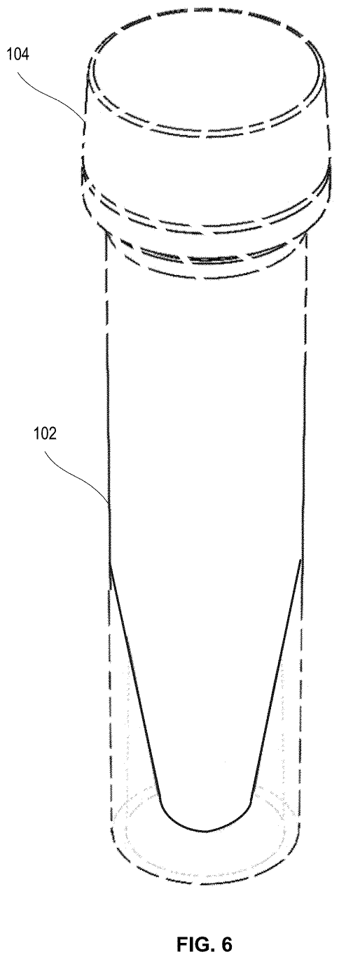

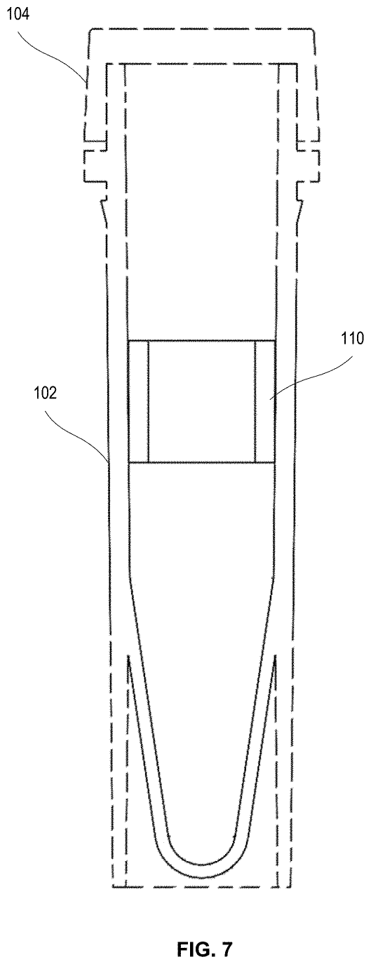

FIG. 6 is a perspective view of an alternate embodiment of the swab lysis tube of FIG. 1, in embodiments. FIG. 7 is a cross-section view of the swab lysis tube of FIG. 6, in embodiments. In embodiments, internal structure 110 may be used with a wide variety of tubes. Tubes may or may not include a sleeve around the tapered end. Caps may be attached with a threaded or snap fit. The tube may not necessarily be used with a cap. The tube may also include other external structures for adapting the tube to use in processing equipment.

FIGS. 8A and 8B depict alternative embodiments of the internal structure 110 as an annular ring, with series of ridges, in embodiments. As discussed above, the series of ridges 113 and 115 may extend within approximately the same length as, or less than, the ring depicted. In the embodiments of FIG. 8A, the series of ridges 113(1), (2) may include pointed or substantially pointed edges. In the embodiments of FIG. 8B, the series of ridges 115(1), (2) may include rounded edges. Further, the embodiments of FIGS. 8A and 8B may include more or fewer (such as one, two, three, and so on) ridges 113, 115 than depicted. Further, the ridges may take any shape or size and is not limited to the depictions of FIGS. 8A, B.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A swab lysis tube, comprising:
a tubular body portion having an interior surface and an exterior surface;
an interior structure extending from the interior surface into a cavity defined by the tubular body portion, said interior structure comprising a lower edge; and
a cap retaining portion at a first end of the tubular body portion opposite a tip.

2. The swab lysis tube of claim 1, wherein the tip is a tapered tip, the interior surface further comprising the tapered tip at an end of the tubular body portion adjacent to the lower surface of the interior structure, said tapered tip having a cross-sectional area equal to the tubular body portion at one end, and a closed tip with a cross-sectional area smaller than that of the tubular body portion at the opposite end.

3. The swab lysis tube of claim 2, wherein the interior structure further comprises a ring with an inner circumference smaller than the circumference of the interior surface and a length of approximately 6 mm.

4. The swab lysis tube of claim 3, the interior structure around the circumference of the tubular body portion at approximately the midpoint along the axis of the tubular body portion.

5. The swab lysis tube of claim 2, wherein the interior structure further comprises a series of ridges with an inner circumference smaller than the circumference of the interior surface and a length of approximately 1 mm, the series of ridges spanning a length of approximately 7 mm.

6. The swab lysis tube of claim 1, wherein the cap retaining portion further comprises threads for retaining an internally threaded cap.

7. The swab lysis tube of claim 6, wherein the cap retaining portion further comprises a first component and a second component, the second component detachable from the cap retaining portion.

8. The swab lysis tube of claim 1, the tube comprising a material such that the tube is not deformed by squeezing or swab manipulation.

9. The swab lysis tube of claim 8, the tube comprising a stiff plastic.

10. The swab lysis tube of claim 9, wherein the stiff plastic is polypropylene.

11. The swab lysis tube of claim 1, the tube comprising a material such that the tube is not deformed by internal or external pressure on walls of the tube.

12. The swab lysis tube of claim 1, wherein the tubular body and the tip comprise a flexible plastic.

13. The swab lysis tube of claim 12, wherein the flexible plastic comprises a low density polyethylene.

14. The swab lysis tube of claim 12, wherein the tubular body, internal structure, and tapered tip comprise a material such that at least the tubular body, internal structure, or tapered tip deforms from internal or external pressure.

15. The swab lysis tube of claim 14, wherein the deformation is inward towards the axis of the tubular portion of the tube.

16. A method of capturing a sample, comprising:
inserting a swab within a swab lysis tube such that a sample of end portion of the swab is mixed with a solution within the swab lysis tube; and
rubbing the swab on an interior structure of the swab lysis tube to express the mixture of solution and sample.

17. The method of claim 16, further comprising:
detaching a component of a cap retaining portion of the swab lysis tube; and
pouring the mixture of solution and sample from the swab lysis tube.

18. The method of claim 16, further comprising squeezing the swab lysis tube such that the interior structure further expresses the mixture of solution and sample.

19. The method of claim 16, wherein the sample is body fluids from a person.
